(19) United States
(12) Patent Application Publication
(10) Pub. No.: US 2008/0060394 A1
(43) Pub. Date: Mar. 13, 2008

(54) LOCK STRUCTURE AND WHEEL LOCK

(76) Inventor: AN-CHEN CHENG, KEELUNG CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/777,617

(22) Filed: Jul. 13, 2007

(30) Foreign Application Priority Data
Sep. 12, 2006 (TW) 95216263

(51) Int. Cl. B60R 25/02; E05B 15/00

(52) U.S. Cl. 70/226; 70/266

(57) ABSTRACT

A wheel lock includes a body, an attaching arm, a movable arm, and a working stick. One end of the attaching arm and the movable arm are disposed on the body. The other end of the attaching arm and the movable arm attach to a wheel. The working stick is slidably disposed on the body. When a user wants to lock the wheel the user simply pulls out the working stick. When a user wants to unlock the wheel the user pushes in the working stick. Therefore, when the user uses the present invention, the user does not need to remove the wheel lock from the steering wheel of the vehicle.

### BACKGROUNG OF THE INVENTION

1. Field of the Invention

The present invention relates to a wheel lock and in particular to a wheel lock that does not be removed whenever the user wishes to lock or unlock a wheel.

2. Description of Related Art

Besides a door lock or an active lock of a car, most people will install more car locks for preventing their car from being stolen. In general, car locks are classified into several types, such as a gear lock or a steering wheel lock. A gear lock is small. However, the gear lock is installed on the gear. When a thief attempts to remove a gear lock, he or she will not be seen by others. Therefore, the chance of the vehicle not being stolen is not decreased significantly. Moreover, a gear lock needs to be installed in a car factory, and the body of the car will be pierced a hole.

A steering wheel lock is attached on the wheel of the car. One end of the steering wheel lock attaches to the body of the car. Because the steering wheel lock is installed in the front of the car, a thief can clearly be seen by other people walking past the vehicle as they attempt to remove the steering wheel lock. However, the steering wheel lock is big and heavy. Furthermore, it must be installed and removed every time when the wheel needs to be locked or unlocked. Therefore, a steering wheel lock often remains unused by car owners who can't be bothered to it every time they leave their vehicle.

### SUMMARY OF THE INVENTION

It is an object of the present invention to provide a wheel lock that locks on the wheel. The wheel lock does not need to be taken off when the wheel is unlocked. When a user wants to lock the wheel the user just has to pull out the working stick. When a user wants to unlock the wheel the user just has to insert the working stick. Therefore, the use of the wheel lock is very convenient.

The other object of the present invention is to provide a lock structure used for the wheel lock, or any other lock.

To achieve the above object, the present invention provides a lock structure, comprising: a body having a curved track and a concave; a guiding lug having a shaft pivoted on one end of the concave, one surface of the guiding lug having a first guiding channel corresponding to the curving track, the opposite surface of the guiding lug having a second guiding channel; a movable arm having a post corresponding to the second guiding channel; and a back lock disposed on the body, the back lock having a bolt; wherein the bolt pushes the shaft to the other end of the concave, the guiding lug is attached on the curving track and the movable arm is attached.

To achieve the above object, the present invention provides a wheel lock, comprising: a body having a hollow pipe; a working stick slidably disposed on the hollow pipe; an attaching arm disposed on the body; a front lock disposed on the body through the attaching arm for attaching the working stick; a movable arm slidably disposed on the body; a back lock disposed on the body for attaching the movable arm.

### BRIEF DESCRIPTION OF THE DRAWINGS

The present invention can be fully understood from the following detailed description and preferred embodiments with reference to the accompanying drawings, in which:

FIG. 1 is an exploded view of the lock structure and the wheel lock according to the present invention;

FIG. 2 is a exploded view of the a guiding lug according to the present invention;

FIG. 3 is a perspective view of the lock structure and the wheel lock according to the present invention;

FIG. 4 is a perspective view of the lock structure and the wheel lock according to the present invention;

FIGS. 5A and 5B are schematic diagrams of the lock structure according to the present invention;

FIG. 6 is an assembled view of the wheel lock and the wheel, with the working stick not installed;

FIG. 7 is an assembled view of the wheel lock and the wheel, in which the wheel is locked; and

FIG. 8 is an assembled view of the wheel lock and the wheel, in which the wheel is unlocked.

### DETAILED DESCRIPTION OF THE PREFERRED EMBODIMENTS

The following detailed description is of the best presently contemplated modes of applying the invention. This description is not intended to be taken in a limiting sense, but is made merely for the purpose of illustrating general principles of embodiments of the invention. The scope of the invention is best defined by the appended claims.

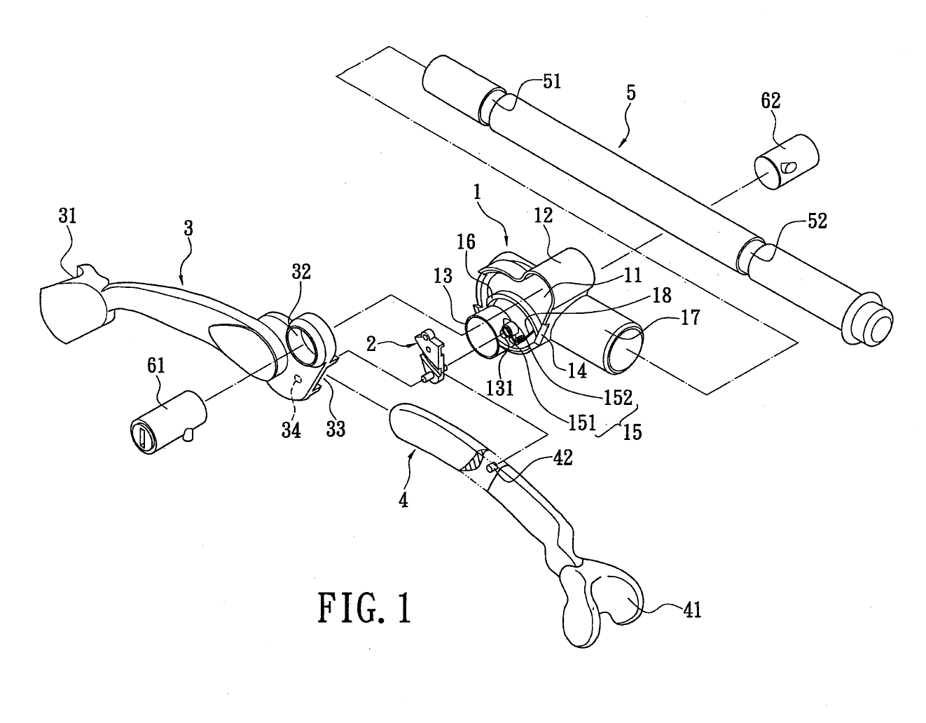

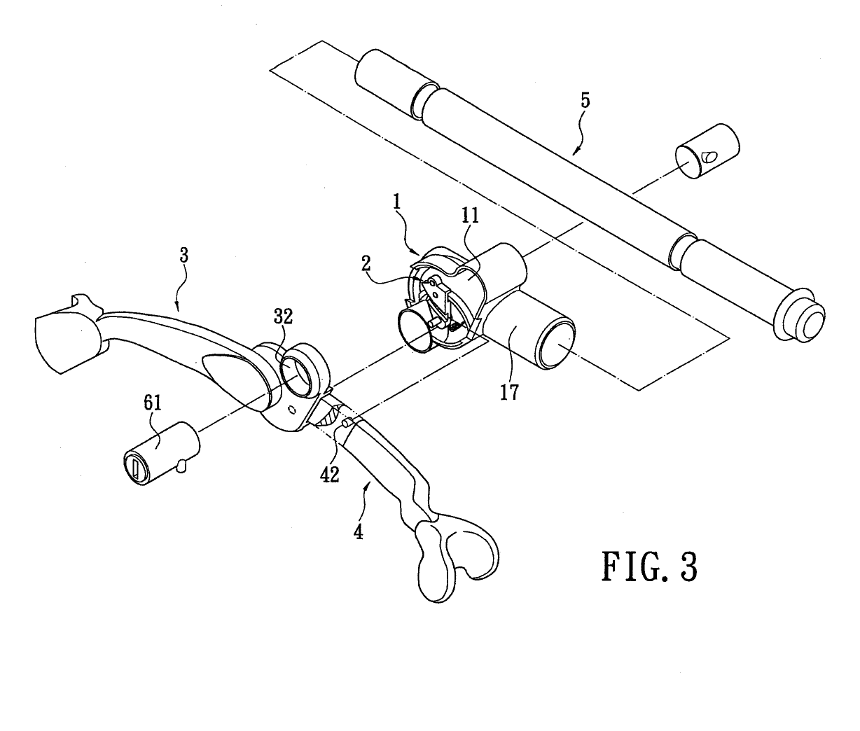

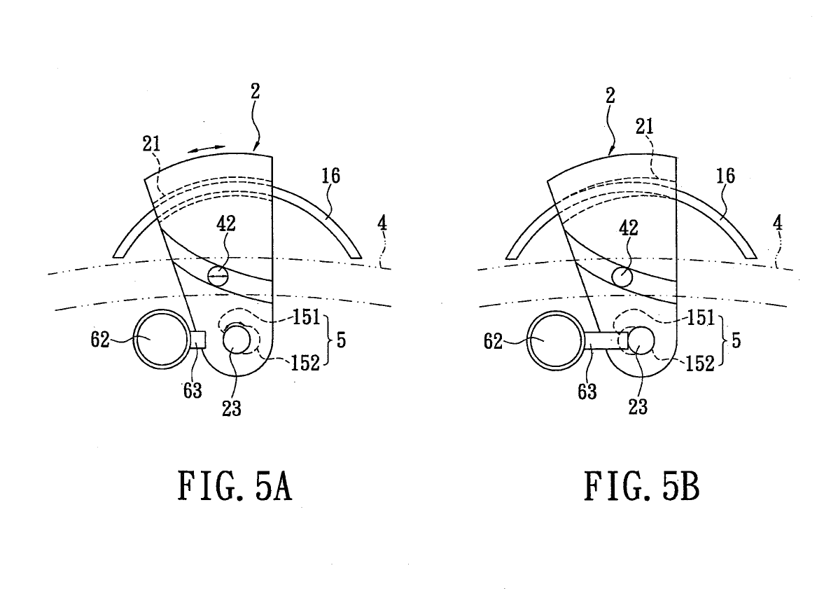

Please refer to FIGS. 1 to 4, a lock structure and a wheel lock of the present invention includes a body 1, a guiding lug 2, an attaching arm 3, a movable arm 4, and a working stick 5. One side of the body 1 has a housing 11. The housing 11 has a curving track 16 and an elliptic concave 15. The concave 15 has a rectangle shape formed on a post protruding from the body 1. The concave 15 has a first part 151 and a second part 152. The curving track 16 has an arc-shaped track protruding from the body 1. The position of the first part 151 of the concave 15 is the center of a circle of the curving track 16. The opposite walls of the housing 11 have two grooves 14 respectively. The other side of the body 1 has a hollow pipe 17 passing through the housing 11. The body 1 has a front lock room 12 in which a front lock 61 is disposed, and the body 1 has a back lock room 13 in which a back lock 62 is disposed. The position of the opening of the front lock room 12 faces the front of the body 1 is near to the hollow pipe 17. A hole (not shown) is disposed on the front lock room 12 for a bolt (not shown) of the front lock 61 to pass through to enter the hollow pipe 17. The opening of the back lock room 13 faces the back of the body 1. The back lock room 13 has a hole 131 facing towards the concave 15. The hole 131 is used for the bolt (refer to FIG. 5A) to pass through. The concave 15 is formed from a hollow post on the body 1.

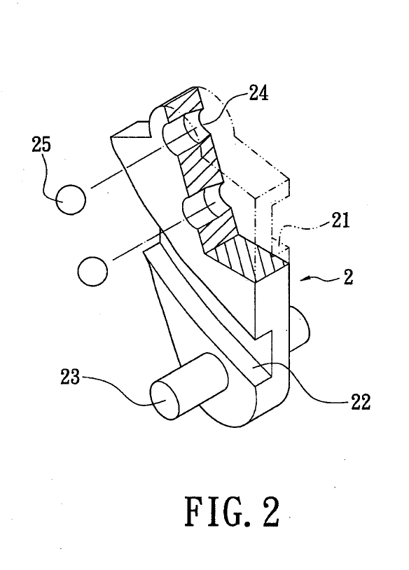

The guiding lug 2 can be moved within the housing 11 of the body 1. Please refer to FIG. 2, in which a shaft 23 is disposed on the guiding lug 2. The shaft 23 protrudes from two opposite surfaces of the guiding lug 2, respectively. The shaft 23 couples to the concave 15 of the body 1 and a concave 34 of the attaching arm 3 respectively. The guiding lug 2 has a first guiding channel 21 and a second guiding groove 22. The first guiding channel 21 corresponds to the curving track 16, and the second guiding channel 22 corresponds to a post 42 of the movable arm 4. An elastic element 18 is disposed in the housing 11 of the body 1 near the concave 15. The elastic element 18 is used to push the shaft 23 to the first part 151 of the concave 15.

Furthermore, the guiding lug 2 has a ball aperture 24 that a ball 25 fits in to. The ball 25 protrudes through the surface facing the body 1 of the guiding lug 2. Therefore, the guiding lug 2 moves along the surface of the body 1 smoother.

One end of the attaching arm 3 has a lock hole 32 that corresponds to the front lock room 12 for attaching the front lock 61. The attaching arm 3 has a third guiding channel 33. A curving claw 31 is formed on the other end of the attaching arm 3. The concave 34 of the attaching arm 3 corresponds to the concave 15 of the body 1. The movable arm 4 is disposed movably on the groove 14 of the body 1 and the third guiding channel 33. A curving claw 41 is formed on one end of the movable arm 4. The attaching arm 3 and the movable arm 4 can be curve-shaped.

The working stick 5 has two round grooves 51, 52 on opposite ends thereof respectively. The working stick 5 is inserted into the hollow pipe 17. The front lock 61 can attach the working stick 5 via at the round grooves 51, 52.

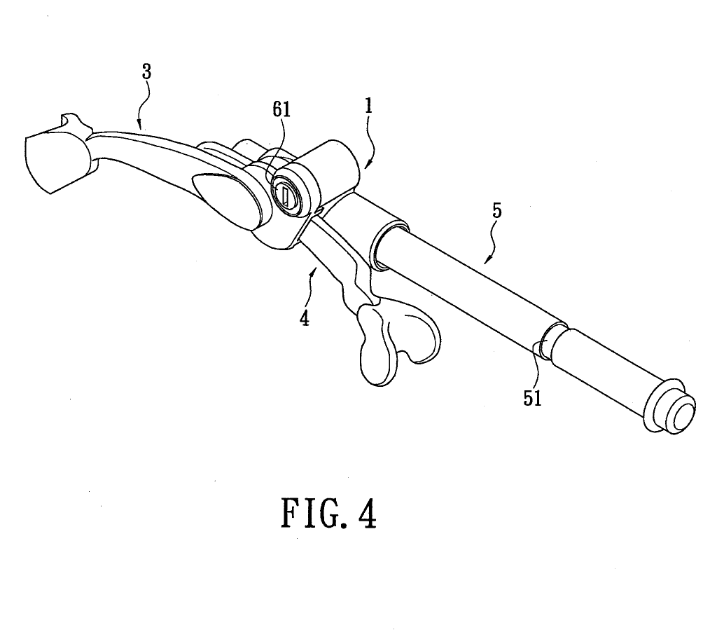

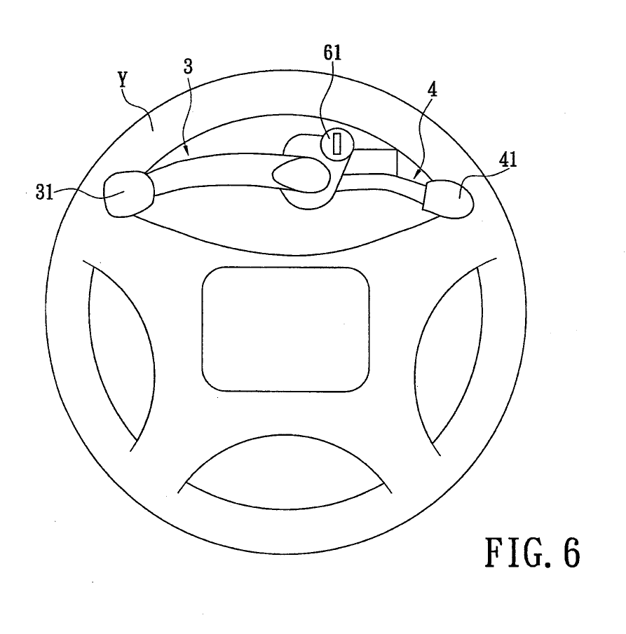

Please refer to FIG. 4, in which the body 1, the attaching arm 3, and the movable arm 4 are assembled. The working stick 5 is movably disposed inside the body 1. Please also refer to FIG. 6. When the present invention is being used the curving claw 31 of the attaching arm 3 is attached to an inner side of a wheel Y. When the movable arm 4 is pulled out the curving claw 41 of the movable arm 4 is allowed to attach to the inner side of the wheel Y. Then the back lock 62 is locked. Therefore, the wheel lock of the present invention is attached onto the wheel Y When a user needs to take off the wheel lock of the present invention, the user need to unlock the back lock 62 and push the movable arm 4 toward the attaching arm 3. The method of moving and attaching the movable arm 4 is described below.

Please refer to FIG. 5A, in which a diagram of the movable arm 4 being moved can be seen. The shaft 23 of the guiding lug 2 is disposed within the first part 151 of the concave 15, and the shaft 23 of the guiding lug 2 is disposed on the center of the circle of the curving track 16. Moreover, the moving path of the first guiding channel 21 of the guiding lug 2 is attached with the curving track 16. Therefore, the guiding lug 2 can pivot with shaft 23, and the first guiding channel 21 moves relative to the curving track 16. When the movable arm 4 is moving, the post 42 within the second guiding channel 22 pushes the guiding lug 2 around.

Please refer to FIG. 5B, in which the movable arm 4 is locked. The bolt 63 of the front lock 62 protrudes from the front lock 62, and the shaft 23 is pushed to the second part 152 of the concave 15. Because the position of the shaft 23 is not the center of the circle of the curving track 16, the moving path of the first guiding channel 21 is not along the curving track 16. In the other words, the guiding lug 2 is attached on the curving track 16 and cannot be moved. Therefore, when the movable arm 4 is pushed, the post 42 is jammed within the second guiding channel 22 and the movable arm 4 cannot be moved anymore.

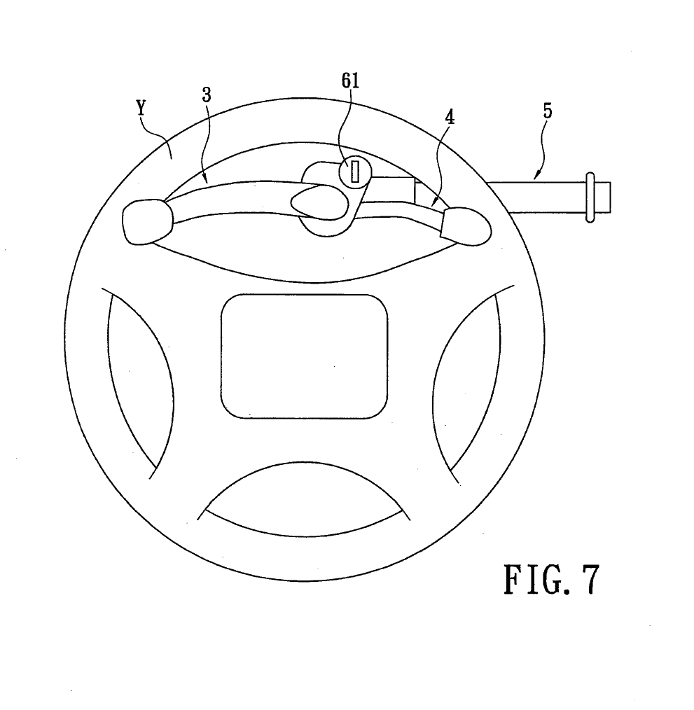

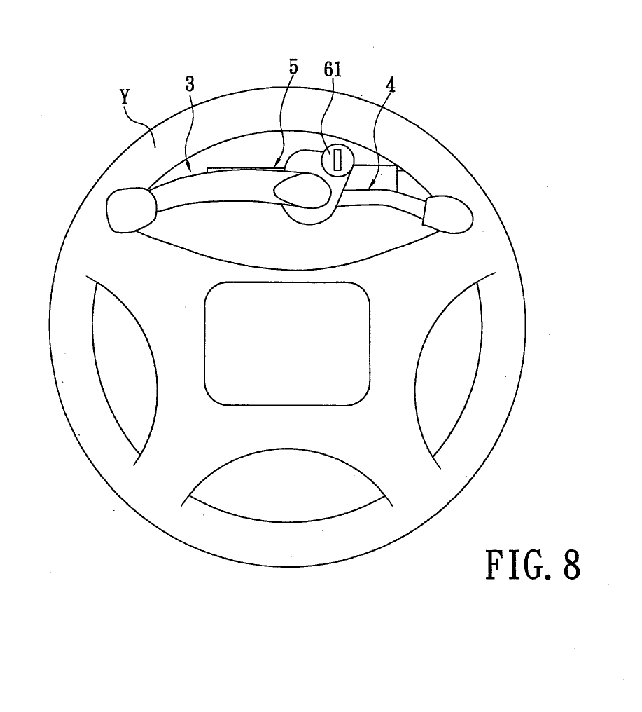

Please refer to FIG. 6, which shows the wheel lock of the present invention attached on the wheel Y As can be seen, there are no structures extending out of the wheel. Therefore, a user does not need to take the wheel lock off when driving his or her car. When a user needs to secure the car against theft, the user just puts the working stick 5 into the hollow pipe 17 of the body 1. And then, referring to FIG. 7, the user locks the front lock 61 to insert the bolt of the front lock 61 into the first round groove 51 to attach the working stick 5. For another method please refer to FIG. 8. The user can lock the front lock 61 at the second round groove 52 of the working stick 5. Therefore, the working stick 5 does not need to be taken off when the user drives.

In conclusion, the present invention does not need to be taken off regardless of whether the present invention is being used or not. Therefore, that is more convenient for users to use.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A lock structure, comprising:
a body having a curving track and a concave;
a guiding lug having a shaft pivoted on one end of the concave, one surface of the guiding lug having a first guiding channel corresponding to the curving track, the opposite surface of the guiding lug having a second guiding channel;
a movable arm having a post corresponding to the second guiding channel; and
a back lock disposed on the body, the back lock having a bolt;
wherein the bolt pushes the shaft to the other end of the concave, the guiding lug is attached on the curving track and the movable arm is attached.

2. The lock structure as claimed in claim 1, wherein the one end of the concave is the center of the circle of the curving track.

3. The lock structure as claimed in claim 1, further comprising an elastic element pushing the shaft of the guiding lug to the other end.

4. The lock structure as claimed in claim 1, wherein the body has a back lock room for attaching the back lock.

5. The lock structure as claimed in claim 1, wherein the body has a groove corresponding to the movable arm.

6. The lock structure as claimed in claim 1, wherein one end of the movable arm has a curving claw, and the movable arm is curved-shade.

7. The lock structure as claimed in claim 1, further comprising an attaching arm disposed on the body, the attaching arm having a curving claw.

8. The lock structure as claimed in claim 1, further comprising a working stick disposed movably on the body.

9. The lock structure as claimed in claim 1, further comprising a front lock disposed on the body for attaching the working stick.

10. The lock structure as claimed in claim 1, further comprising a ball, and the guiding lug 2 having a ball aperture for the ball to attach to.

11. A wheel lock, comprising:
a body having a hollow pipe;
a working stick slidably disposed on the hollow pipe;
an attaching arm disposed on the body;
a front lock disposed on the body through the attaching arm for attaching the working stick;
a movable arm slidably disposed on the body;
a back lock disposed on the body for attaching the movable arm.

12. The wheel lock as claimed in claim 11, wherein the attaching arm and the movable arm are curved, and one end of the attaching arm and the movable arm each have a curving claw respectively.

13. The wheel lock as claimed in claim 11, wherein the body has a curving track and an elliptic concave.

14. The wheel lock as claimed in claim 13, further comprising a guiding lug having a shaft pivoted on one end of the concave, one surface of the guiding lug having a first guiding channel corresponding to the curving track, the opposite surface of the guiding lug having a second guiding channel.

15. The wheel lock as claimed in claim 14, wherein the movable arm has a post corresponding to the second guiding channel.

16. The wheel lock as claimed in claim 14, further comprising an elastic element pushing the shaft of the guiding lug to the other end.

17. The wheel lock as claimed in claim 14, further comprising a ball, and the guiding lug 2 has a ball aperture for the ball to attach to.
